(19) United States
(12) Patent Application Publication
(10) Pub. No.: US 2017/0214992 A1
(43) Pub. Date: Jul. 27, 2017

(54) Music Stand With Threaded Shaft Lug

(71) Applicant: The Music People, Inc., Berlin, CT (US)

(72) Inventor: James R. Hennessey, West Hartford, CT (US)

(21) Appl. No.: 15/407,705

(22) Filed: Jan. 17, 2017

Related U.S. Application Data
(60) Provisional application No. 62/281,620, filed on Jan. 21, 2016.

(51) Int. Cl. H04R 1/08; F16M 11/24; F16B 7/18; F16M 11/16

(52) U.S. Cl. CPC H04R 1/08; F16M 11/16; F16M 11/24; F16B 7/18

(57) ABSTRACT

A music stand includes a shaft, a lug, and a base. The shaft is hollow and extends along a longitudinal shaft axis in a direction between a proximal end and a distal end of the shaft. The lug is integrally formed with the proximal end of the shaft via welding. The lug is solid throughout and includes lug threads on an outer surface thereof. The base has a base body and a base bore extends at least partially through the base body. The base body has an inner surface that defines the base bore and base bore threads. The shaft and the base are threadably connectable with one another via the lug threads and the base bore threads. The lug threads and the base bore threads conform to ISO Metric Thread Designation M20.

### CROSS-REFERENCE TO RELATED APPLICATIONS

The present disclosure claims priority to U.S. Provisional Patent Application No. 62/281,620, filed Jan. 21, 2016.

### TECHNICAL FIELD

The present disclosure relates to a music stand, and more particularly relates to a music stand with a shaft and a base that are threadably connected to one another.

### BACKGROUND

It is known to provide a music stand (e.g., to hold a microphone, sheet music, etc.) that includes a shaft and a base. The proximal end of the shaft can include a threaded portion configured to be connected to a corresponding threaded portion of the base. The respective threaded portions of the shaft and the base typically have a relatively low pitch, and thus the shaft and base must be rotated relative to one another a relatively high number of times in order to screw in or connect the shaft with the base. This can be time consuming and annoying. Additionally, referring to FIG. 1, the threaded portion 2 of the proximal end 3 of the shaft 4 typically includes threads 5 ground into an outer surface 6 of a shaft wall 7 of the shaft 4. This can be problematic because the threads 5 reduce the thickness, and thus the structural integrity, of the shaft wall 7. This problem can be overcome by providing the shaft 4 with a relatively thicker shaft wall 7; however, this increases production costs and design inefficiencies. Aspects of the present invention are directed to these and other problems.

### SUMMARY

According to an aspect of the present invention, a music stand is provided that includes a shaft, a lug, and a base. The shaft is hollow and extends along a longitudinal shaft axis in a direction between a proximal end and a distal end of the shaft. The lug is integrally formed with the proximal end of the shaft via welding. The lug is solid throughout and includes lug threads on an outer surface thereof. The base has a base body and a base bore extends at least partially through the base body. The base body has an inner surface that defines the base bore and base bore threads. The shaft and the base are threadably connectable with one another via the lug threads and the base bore threads. The lug threads and the base bore threads conform to ISO Metric Thread Designation M20.

In addition to, or as an alternative to, one or more of the features described above, further aspects of the present invention can include one or more of the following features, individually or in combination:
the lug threads and the base bore threads conform to one of ISO Metric Thread Designations M20×2.5, M20×0.75, M20×1, M20×1.5, and M20×2;
the lug threads and the base bore threads conform to ISO Metric Thread Designation M20×2.5;
the lug threads and the base bore threads are coarse threads;
the base is in the form of a trip-pod;
the base is a dome-shaped round base;
the shaft includes a tubular shaft wall and a cylindrical shaft channel defined by an inner surface of the shaft wall, and the shaft channel extends through the shaft along the shaft axis;
the lug includes an anchor portion integrally formed with the proximal end of the shaft via welding, and a threaded portion extends from the anchor portion;
the anchor portion of the lug is received at least partially within the shaft channel;
the threaded portion of the lug is cylindrical and extends along the shaft axis;
the threaded portion of the lug has an outer surface that extends circumferentially about the shaft axis;
the outer surface of the threaded portion of the lug defines the lug threads;
the lug threads define a pitch and a pitch diameter;
the pitch diameter is less than an outer diameter of the shaft wall of the shaft;
the pitch diameter is at least substantially equal to an outer diameter of the shaft wall;
the shaft includes a shaft washer that extends radially outward from the shaft wall, and the shaft washer is configured to assist a user in positioning of the shaft relative to the base;
the base bore is cylindrical and extends partially through the base body along a longitudinal base bore axis in a direction between a proximal end and a distal end of the base body;
the base bore has a length, and the length of the base bore is equal to or greater than the length of a threaded portion of the lug;
the base bore threads extend radially into the base bore; and
the base bore threads define a pitch and a pitch diameter, and the pitch and the pitch diameter of the base bore threads are at least substantially equal to a pitch and a pitch diameter of the lug threads, respectively.

These and other aspects of the present invention will become apparent in light of the drawings and detailed description provided below.

### BRIEF DESCRIPTION OF THE DRAWINGS

FIG. 1 is a cross-sectional elevation view of a portion of a prior art shaft for a music stand.

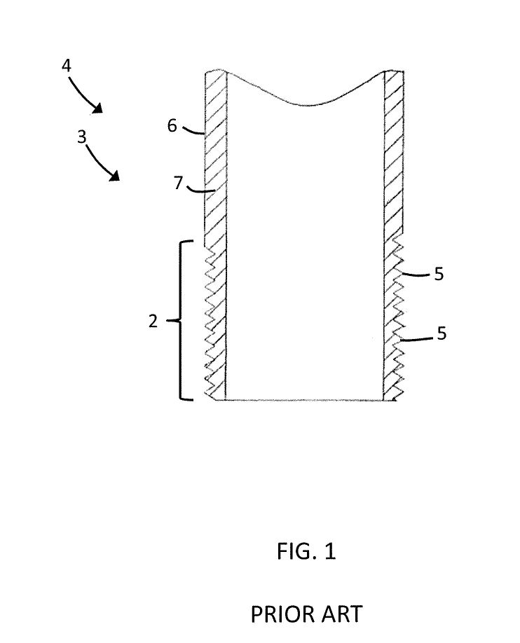

FIG. 2 is a perspective view of an embodiment of the present music stand.

FIG. 3 is a perspective view of a portion of the shaft and the lug of the music stand of FIG. 2.

FIG. 4 is a cross-sectional elevation view of a portion of the shaft and the lug of the music stand of FIG. 2.

FIG. 5 is a perspective view of a portion of the shaft and the lug of another music stand embodiment.

FIG. 6 is a cross-sectional elevation view of a portion of the shaft and the lug of another music stand embodiment.

FIG. 7 is a perspective view of the base of the music stand of FIG. 2.

FIG. 8 is perspective view of the base of another music stand embodiment.

### DETAILED DESCRIPTION

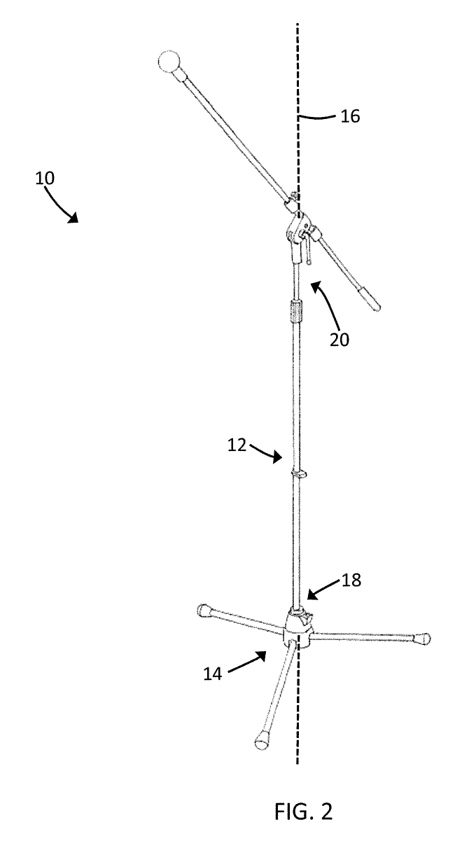

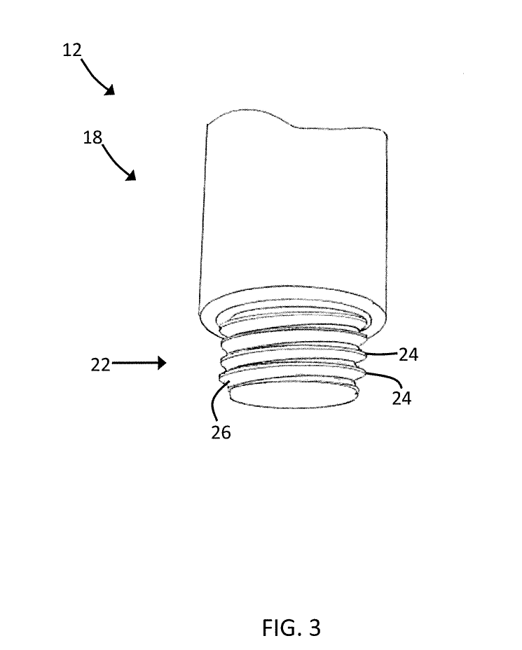

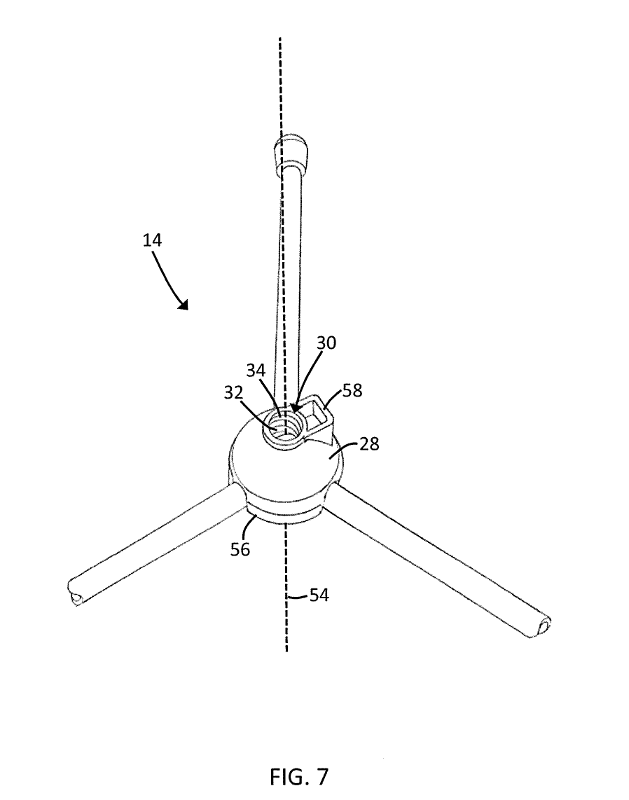

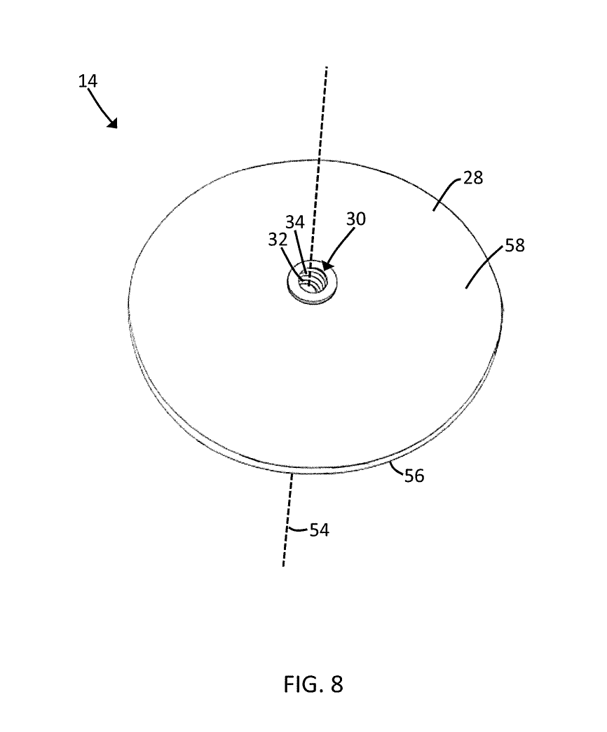

Referring to FIG. 2, the music stand 10 includes a shaft 12 and a base 14. The shaft 12 is hollow and extends along a longitudinal shaft axis 16 in a direction between a proximal end 18 and a distal end 20 of the shaft 12. Referring to FIGS. 3-6, the music stand 10 also includes a lug 22 integrally formed with the proximal end 18 of the shaft 12 (e.g., via welding). The lug 22 includes lug threads 24 (e.g., helical or spiral ribs or grooves) on an outer surface 26 thereof. Referring to FIGS. 7 and 8, the base 14 includes a base body 28 and a base bore 30 extending at least partially through the base body 28. The base body 28 has an inner surface 32 that defines the base bore 30 and base bore threads 34 (e.g., helical or spiral ribs or grooves). The shaft 12 and the base 14 are threadably connectable with one another via the lug threads 24 and the base bore threads 34.

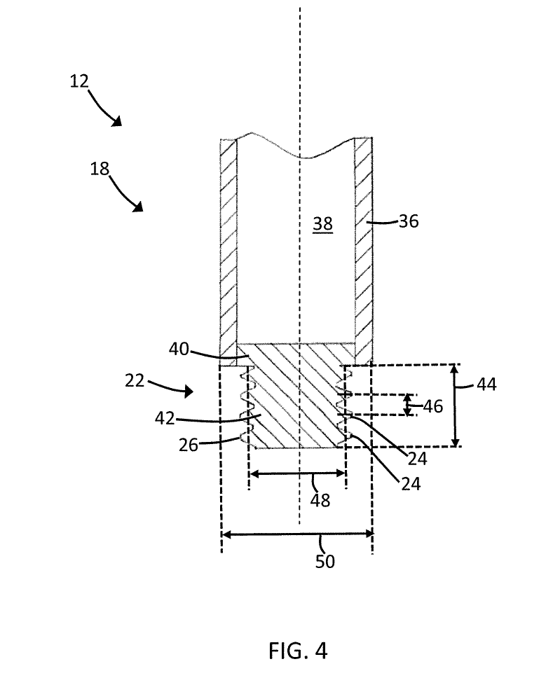

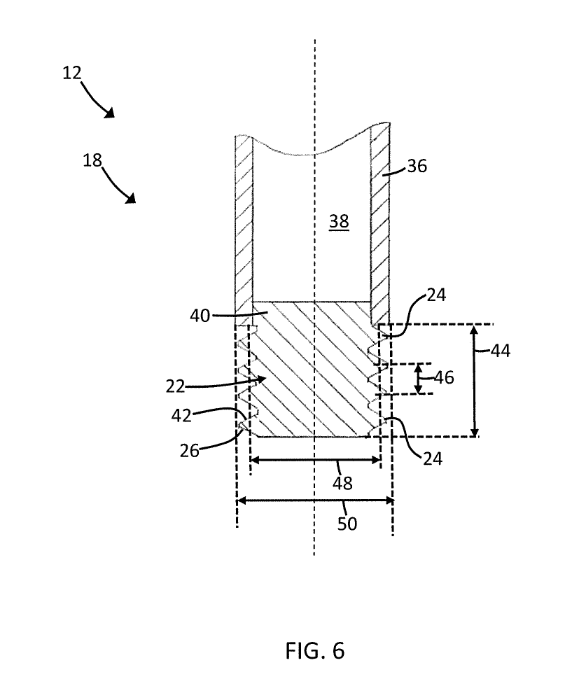

Referring to FIGS. 4 and 6, in the illustrated embodiments, the shaft 12 includes a tubular shaft wall 36 and a cylindrical shaft channel 38 defined by an inner surface 32 of the shaft wall 36. The shaft channel 38 extends through the shaft 12 along the shaft axis 16.

In the illustrated embodiments, the lug 22 is solid throughout, and includes an anchor portion 40 connected (e.g., integrally connected via welding) to the proximal end 18 of the shaft 12, and a threaded portion 42 extending from the anchor portion 40. The anchor portion 40 of the lug 22 is received at least partially within the shaft channel 38. The threaded portion 42 of the lug 22 is cylindrical and extends along the shaft axis 16. The threaded portion 42 of the lug 22 has a length 44 (i.e., a dimension in the direction of the shaft axis 16) that can vary depending on the particular embodiment.

The threaded portion 42 of the lug 22 has an outer surface 26 extending circumferentially about the shaft axis 16. The outer surface 26 of the threaded portion 42 of the lug 22 defines the lug threads 24. The lug threads 24 define a pitch 46 and a pitch diameter 48. The pitch diameter 48 can vary depending on the particular embodiment. In some embodiments, the pitch diameter 48 can be in a range between 18.2 mm and 19.7 mm, and more particularly in a range between 18.2 mm and 18.4 mm. In some embodiments, the lug threads 24 conform to ISO Metric Thread Designation M20 (e.g., M20×2.5, M20×0.75, M20×1, M20×1.5, or M20×2). The lug threads 24 can thus be coarse in comparison to those of prior art music stands. In some embodiments, the lug threads 24 can be configured to have a tolerance class of 6g or 4g6g, for example. In some embodiments (see FIG. 4), the pitch diameter 48 is less than an outer diameter 50 of the shaft wall 36 of the shaft 12. In other embodiments, the pitch diameter 48 is at least substantially equal to (see FIG. 6) or greater than (not shown) the outer diameter 50 of the shaft wall 36.

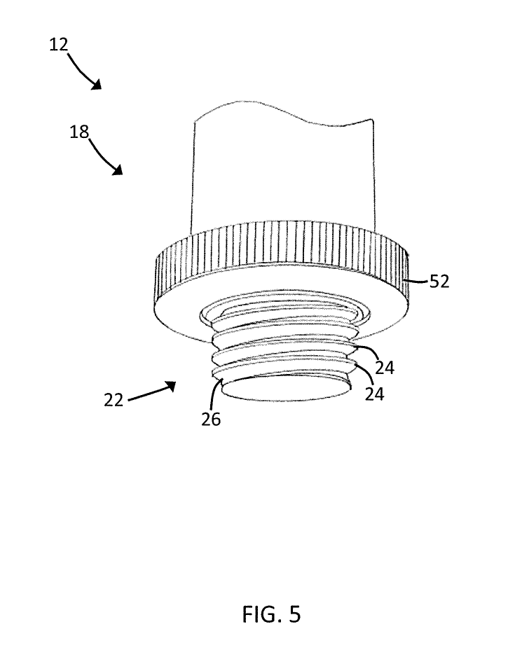

In some embodiments (see FIG. 5), the shaft 12 can additionally include a shaft washer 52 extending radially outward from the shaft wall 36. The shaft washer 52 can assist a user in positioning of the shaft 12 relative to the base 14.

Referring to FIGS. 7 and 8, in the illustrated embodiments, the base bore 30 is cylindrical and extends partially through the base body 28 along a longitudinal base bore axis 54 in a direction between a proximal end 56 and a distal end 58 of the base body 28. The base bore 30 has a length (i.e., a dimension in the direction of the base bore axis 54). The length of the base bore 30 is equal to or greater than the length of the threaded portion 42 of the lug 22. The base bore threads 34 extend radially into the base bore 30. The base bore threads 34 define a pitch (not shown) and a pitch diameter (not shown). The pitch and pitch diameter of the base bore threads 34 are selected to correspond to (e.g., are at least substantially equal to) the pitch 46 and pitch diameter 48 of the lug threads 24, respectively. In some embodiments, the pitch diameter of the base bore threads 34 can be in a range between 18.2 mm and 19.7 mm, and more particularly in a range between 18.2 mm and 18.4 mm. In some embodiments, the base bore threads 34 can conform to ISO Metric Thread Designation M20 (e.g., M20×2.5, M20×0.75, M20×1, M20×1.5, or M20×2). The base bore threads 34 can thus be coarse in comparison to those of prior art music stands. In some embodiments, the base bore threads 34 can be configured to have a tolerance class of 6g or 4g6g, for example. In the embodiment of FIG. 7, the base 14 is in the form of a tri-pod. In the embodiment of FIG. 8, the base 14 is a dome-shaped round base.

The music stand 10 is advantageous relative to prior art music stands in that it provides a threaded connection between the shaft 12 and the base 14 without reducing the thickness of the shaft wall 36. The structural integrity of the shaft wall 36 (and thus the shaft 12 and the music stand 10 as a whole) is thus greater than that of prior art music stands.

The present disclosure describes aspects of the invention with reference to the exemplary embodiments illustrated in the drawings; however, aspects of the invention are not limited to the exemplary embodiments illustrated in the drawings. It will be apparent to those of ordinary skill in the art that aspects of the invention include many more embodiments. Accordingly, aspects of the invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A music stand, comprising:
a shaft that is hollow and extends along a longitudinal shaft axis in a direction between a proximal end and a distal end of the shaft;
a lug integrally formed with the proximal end of the shaft via welding, the lug being solid throughout and including lug threads on an outer surface thereof; and
a base having a base body and a base bore extending at least partially through the base body, the base body having an inner surface that defines the base bore and base bore threads;
the shaft and the base threadably connectable with one another via the lug threads and the base bore threads;
the lug threads and the base bore threads conforming to ISO Metric Thread Designation M20.

2. The music stand of claim 1, wherein the lug threads and the base bore threads conform to one of ISO Metric Thread Designations M20×2.5, M20×0.75, M20×1, M20×1.5, and M20×2.

3. The music stand of claim 2, wherein the lug threads and the base bore threads conform to ISO Metric Thread Designation M20×2.5.

4. The music stand of claim 1, wherein the lug threads and the base bore threads are coarse threads.

5. The music stand of claim 1, wherein the base is in the form of a trip-pod.

6. The music stand of claim 1, wherein the base is a dome-shaped round base.

7. The music stand of claim 1, wherein the shaft includes a tubular shaft wall and a cylindrical shaft channel defined by an inner surface of the shaft wall, and the shaft channel extends through the shaft along the shaft axis.

8. The music stand of claim 7, wherein the lug includes an anchor portion integrally formed with the proximal end of the shaft via welding, and a threaded portion extending from the anchor portion.

9. The music stand of claim 8, wherein the anchor portion of the lug is received at least partially within the shaft channel.

10. The music stand of claim 8, wherein the threaded portion of the lug is cylindrical and extends along the shaft axis.

11. The music stand of claim 8, wherein the threaded portion of the lug has an outer surface extending circumferentially about the shaft axis.

12. The music stand of claim 11, wherein the outer surface of the threaded portion of the lug defines the lug threads.

13. The music stand of claim 7, wherein the lug threads define a pitch and a pitch diameter.

14. The music stand of claim 13, wherein the pitch diameter is less than an outer diameter of the shaft wall of the shaft.

15. The music stand of claim 13, wherein the pitch diameter is at least substantially equal to an outer diameter of the shaft wall.

16. The music stand of claim 7, wherein the shaft includes a shaft washer extending radially outward from the shaft wall, the shaft washer configured to assist a user in positioning of the shaft relative to the base.

17. The music stand of claim 1, wherein the base bore is cylindrical and extends partially through the base body along a longitudinal base bore axis in a direction between a proximal end and a distal end of the base body.

18. The music stand of claim 1, wherein the base bore has a length, and the length of the base bore is equal to or greater than the length of a threaded portion of the lug.

19. The music stand of claim 1, wherein the base bore threads extend radially into the base bore.

20. The music stand of claim 1, wherein the base bore threads define a pitch and a pitch diameter; and
wherein the pitch and the pitch diameter of the base bore threads are at least substantially equal to a pitch and a pitch diameter of the lug threads, respectively.
